(19) United States
(12) Patent Application Publication
(10) Pub. No.: US 2025/0058499 A1
(43) Pub. Date: Feb. 20, 2025

(54) DIAMOND WIRE MULTI-WIRE CUTTING MACHINE AND CUTTING DEVICE THEREOF, AND SILICON INGOT SLICING PRODUCTION LINE

(71) Applicant: Hunan Yiyuan New Material Technology Co., Ltd, Yiyang (CN)

(72) Inventors: Jiawei YANG, Yiyang (CN); Tao GONG, Yiyang (CN); Hong PENG, Yiyang (CN); Weijie HAO, Yiyang (CN); Shan CHEN, Yiyang (CN); Jing HE, Yiyang (CN)

(73) Assignee: Hunan Yiyuan New Material Technology Co., Ltd, Yiyang (CN)

(21) Appl. No.: 18/536,678

(22) Filed: Dec. 12, 2023

(30) Foreign Application Priority Data
Aug. 18, 2023 (CN) 2023110411767

(51) Int. Cl. B28D 5/04; B28D 5/00

(52) U.S. Cl. CPC B28D 5/045; B28D 5/0082

(57) ABSTRACT

The present invention discloses a cutting device, where the cutting device includes a cutting head, a main shaft system, and at least four eccentric shaft sleeves; the cutting head is provided with a frame main body and at least four shaft holes; the main shaft system includes a set of rollers, a set of bearing box assemblies, and locking screw assemblies; the eccentric shaft sleeves can be mounted in the shaft holes in an axial sliding manner, a bearing box is disposed inside each eccentric shaft sleeve; one support arm is disposed on each eccentric shaft sleeve; limiting mechanisms are disposed on the frame main body, and are combined with the shaft holes; each limiting mechanism includes at least two limiting clamping seats and fasteners; the support arm and the limiting clamping seat can form a limiting fit after the eccentric shaft sleeve is inserted into the corresponding shaft hole.

### CROSS-REFERENCE TO RELATED APPLICATIONS

The application claims priority to Chinese patent application No. 2023110411767, filed on Aug. 18, 2023, the entire contents of which are incorporated herein by reference.

### TECHNICAL FIELD

The present invention generally relates to equipment for forming thin substrates from silicon ingots, and in particular to a production line for slicing silicon ingots. The present invention further relates to a cutting device and a diamond wire multi-wire cutting machine including the cutting device, for cutting cast ingot materials of semiconductors, solar batteries, or light-emitting diodes to obtain material slices.

### BACKGROUND

EP2826582A1 discloses a wire saw device, where the wire saw device includes a cutting head, at least four bearing box sleeves, and a temperature control protective cover arrangement; the cutting head is provided with a frame main body and at least four openings, and the at least four openings are configured to receive a set of wire guider barrels; the temperature control protective cover arrangement is provided with one or more temperature control protective covers; the frame main body is made of mineral castings and combined with the at least four bearing box sleeves and the one or more temperature control protective covers; and the at least four bearing box sleeves can be bonded and/or pressed in one of the at least four openings. Each bearing box sleeve has a circular form and can be provided for high-precision mounting of a bearing box, together with the frame main body made of mineral castings, to achieve high precision of concentricity, parallelism, and/or verticality of the wire guider barrels.

A center distance between the two wire guider barrels of the wire saw device is fixed, and a size of a to-be-cut workpiece also needs to be within a certain range. If the to-be-cut workpiece is too small, a length of a part which is not in contact with the to-be-cut workpiece, of the wire will become longer, causing a decrease in tension and/or an increase in vibration, which is harmful to cutting quality; and if the to-be-cut workpiece is too large and cannot be machined due to the limitation of the center distance between the two wire guider barrels, the wire saw device with a larger center distance needs to be equipped, and required investment needs to be doubled. With an increasing demand for diversified cast ingot materials in the market, such situations are becoming more and more common. Here, the to-be-cut workpiece generally refers to cast ingot materials, including materials such as gallimn arsenide, germanium, polycrystalline silicon or monocrystalline silicon, indium phosphide, quartz, sapphire or other ceramic materials.

CN 112719444 A discloses a multi-wire cutting machine, where a cutting device of the multi-wire cutting machine includes a frame main body, and a main shaft system; four bearing seat holes are formed in the frame main body and used for mounting the main shaft system; the main shaft system includes a main shaft motor, a motor mounting seat, a driving shaft assembly, a driven shaft assembly, a locking screw, and a shaft roll; and a function of the shaft roll (or called a roller) of the main shaft system is similar to or same as that of the wire guider barrel mentioned above. With an increasing demand for diversified cast ingot materials in the market, the multi-wire cutting machine faces the same technical problem as the wire saw device disclosed in EP 2826582 A1 that adaptability to to-be-cut workpieces of different sizes and specifications is poor. Therefore, there is a need for a multi-wire cutting machine which can adapt to diversified to-be-cut workpieces of different sizes and specifications in the art.

### SUMMARY

In view of the above content, one objective of the present invention is to provide a cutting device and a diamond wire multi-wire cutting machine including the cutting device, which can adapt to diversified to-be-cut workpieces of different sizes and specifications.

In one embodiment, the cutting device includes a cutting head, a main shaft system, and at least four eccentric shaft sleeves, where the cutting head is provided with a frame main body and at least four shaft holes; the main shaft system includes a set of rollers and a set of bearing box assemblies for supporting the set of rollers, as well as locking screw assemblies for locking axial positions of the rollers; each of the at least four eccentric shaft sleeves is capable of being mounted in one of the at least four shaft holes in an axial sliding manner, and one of bearing boxes in the set of bearing box assemblies is disposed in each of the at least four eccentric shaft sleeves; one support arm is disposed on each of the at least four eccentric shaft sleeves; at least four sets of limiting mechanisms are disposed on the frame main body; each set of limiting mechanisms is combined with one of the at least four shaft holes; each set of limiting mechanisms comprises at least two limiting clamping seats and fasteners; after the eccentric shaft sleeves are inserted into the corresponding shaft holes, the support arms are capable of forming a limiting fit with the limiting clamping seats; the fasteners are used for fastening the support arms to the limiting clamping seats; and the support arms cooperate with different limiting clamping seats among the at least two limiting clamping seats to limit the eccentric shaft sleeves to different angles.

Preferably, each set of limiting mechanisms further includes at least one guide rod, a guide hole cooperating with the guide rod is formed in the support arm, and the guide rod is parallel or roughly parallel to a centerline of the shaft hole, so that the eccentric shaft sleeve integrated with the support arm does not rotate during axial movement.

Preferably, a guide mounting hole for mounting the guide rod is formed in each of the at least two limiting clamping seats, and the guide rod is capable of mounted on another limiting clamping seat after being disassembled from one of the at least two limiting clamping seats; and in addition, the guide mounting hole can be directly formed in the frame main body.

Preferably, each set of limiting mechanisms includes at least three limiting clamping seats and fasteners, and the at least limiting clamping seats are located on a same plane.

Preferably, a distance from each of the at least three limiting clamping seats to a centerline of the corresponding shaft hole is the same, and a distance between any two adjacent limiting clamping seats of the at least three limiting clamping seats is the same as a distance between the other two adjacent limiting clamping seats.

Preferably, the support arm is disposed on the eccentric shaft sleeve by fastened connection or welding, fixed connection.

Preferably, the cutting device includes six eccentric shaft sleeves, the cutting head is provided with six shaft holes, the main shaft system includes three rollers and three bearing box assemblies for supporting the three rollers, and three locking screw assemblies for locking axial positions of the rollers; and six sets of limiting mechanisms are disposed on the frame main body.

Preferably, at least two sliding grooves are formed in each of the at least four shaft holes, one sliding key is in fastened connection or fixed connection to each of the at least four eccentric shaft sleeves, and the sliding key is capable of cooperating with each of the at least two sliding grooves. When the sliding key is combined with each of the at least two sliding grooves, a radial angle of the eccentric shaft sleeve is limited to a different position, and the eccentric shaft sleeve does not rotate when moving axially.

Preferably, at least two sliding grooves are formed in each of the at least four shaft holes, each of the at least four eccentric shaft sleeves is provided with one sliding tooth integrated with the eccentric shaft sleeve, and the sliding tooth is capable of cooperating with each of the at least two sliding grooves. When the sliding tooth is combined with each of the at least two sliding grooves, a radial angle of the eccentric shaft sleeve is limited to a different position, and the eccentric shaft sleeve does not rotate when moving axially.

In yet another embodiment, the diamond wire multi-wire cutting machine includes a machine frame, and a cutting device, a feeding system, a wire guide system, a tension system, a wire arrangement system and a wire take-up and pay-off system which are disposed on the machine frame, as well as a mortar bucket located below the machine frame. The cutting device is mounted at a front end of the machine frame, the feeding system is mounted above the cutting device, the wire take-up and pay-off system consists of two wire take-up and pay-off components symmetrically arranged below a left side and a right side of the cutting device, the wire guide system consists of two wire guide components symmetrically arranged below the left side and the right side of the cutting device, the tension system consists of two tension components symmetrically arranged below the left side and the right side of the cutting device, and the wire arrangement system consists of two wire arrangement components symmetrically arranged below the left side and the right side of the cutting device.

Another objective of the present invention is to provide a silicon ingot slicing production line for slicing silicon ingots, and the silicon ingot slicing production line includes:
a track, where the track is arranged linearly, a row of diamond wire multi-wire cutting machines is arranged on each of two sides of the track, and each row includes at least three diamond wire multi-wire cutting machines;
a roller conveyor, where the roller conveyor is arranged on one side of the track, and used for conveying workpieces with adhesive plates;
a charging machine, where the charging machine cooperates with the roller conveyor, and is used for rolling over the workpieces with adhesive plates delivered by the roller conveyor, so that the adhesive plates of the workpieces with adhesive plates face upwards;
a temporary storage table, where the temporary storage table is arranged on one side of the track and opposite to the charging machine, and used for temporary storage of materials;
a loading and unloading robot, where the loading and unloading robot is movably disposed on the track, and used for transporting the workpieces with adhesive plates to the temporary storage table, transporting the workpieces with adhesive plates on the temporary storage table to the diamond wire multi-wire cutting machines, taking out the machined workpieces from the diamond wire multi-wire cutting machines and moving the taken workpieces to a discharge end of the track; and
a discharging machine, where the discharging machine is arranged at the discharge end of the track, and used for receiving the machined workpieces and performing a discharging operation.

Preferably, the charging machine and the temporary storage table are located on two sides of a middle part of the track; the roller conveyor, the charging machine, the temporary storage table, the discharging machine, and the track are all mounted on the ground; and the roller conveyor is located between the track and the row of diamond wire multi-wire cutting machines.

Compared to the background, the present invention generally has the following beneficial effects. The present invention provides a cutting device and a diamond wire multi-wire cutting machine including the cutting device, which can adapt to the diversified to-be-cut workpieces of different sizes and specifications by adjusting a distance between rollers by adjusting locking positions of the eccentric shaft sleeves. Moreover, positions of the eccentric shaft sleeves can be easily adjusted by loosening nuts of the locking screw assemblies and releasing the limitation of the limiting mechanisms on the support arms, and then, the nuts of the locking screw assemblies are re-tightened and the support arms are limited to new positions to complete position adjustment on the rollers, so that the adjustment manner is simple to operate.

### BRIEF DESCRIPTION OF DRAWINGS

In drawings that may not necessarily be drawn to scale, same numbers can describe similar components in different views. The same numbers with different letter suffixes can represent different instances of the similar components. The drawings illustrate generally, by way of example, but not by way of limitation, various embodiments discussed herein.

FIG. 1 shows a perspective structural diagram of an optional embodiment of a diamond wire multi-wire cutting machine.

FIG. 2 shows a perspective structural diagram of an optional embodiment of a frame main body of a cutting device in FIG. 1.

FIG. 3 shows a schematic exploded diagram of an optional embodiment of a main shaft system of the cutting device in FIG. 1.

FIG. 4 shows a schematic sectional view of an optional embodiment of the main shaft system of the cutting device in FIG. 1.

FIG. 5 is a partial enlarged view of FIG. 1, showing a part of the cutting device, including apart of the main shaft system, eccentric shaft sleeves, limiting mechanisms, and support arms.

FIG. 6 is a partial sectional view of another optional embodiment of the cutting device in FIG. 1 or FIG. 5, showing a schematic cross-sectional view of shaft holes and the eccentric shaft sleeves of the frame main body, and reflecting two different cooperating structures.

FIG. 7 is a schematic sectional view of an optional embodiment of a wire take-up and pay-off component in FIG. 1.

FIG. 8 is a perspective structural diagram of wire guide components in FIG. 1.

FIG. 9 is a perspective structural diagram of a tension component in FIG. 1.

FIG. 10 is a perspective structural diagram of a wire arrangement component in FIG. 1.

FIG. 11 is a perspective structural diagram of a feeding system in FIG. 1.

FIG. 12 shows a layout plan of an optional embodiment of a silicon ingot slicing production line.

### DETAILED DESCRIPTION OF THE EMBODIMENTS

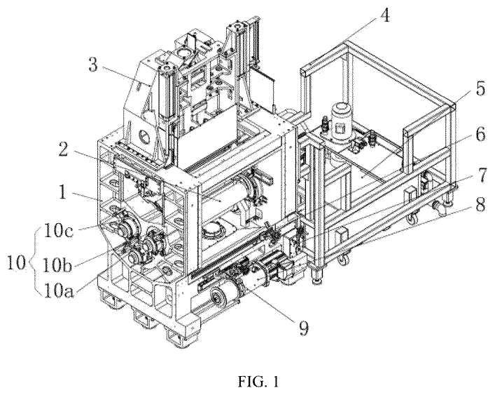

FIG. 1 shows a perspective structural diagram of an optional embodiment of a diamond wire multi-wire cutting machine. The diamond wire multi-wire cutting machine includes a machine frame 4, and a cutting device, a feeding system 3, a wire guide system, a tension system, a wire arrangement system, a wire take-up and pay-off system which are disposed on the machine frame 4, as well as a mortar bucket 5 located below the machine frame 4.

The cutting device is mounted at a front end of the machine frame 4, the feeding system 3 is mounted above the cutting device, the wire take-up and pay-off system consists of two wire take-up and pay-off components 8 symmetrically arranged below a left side and a right side of the cutting device, the wire guide system consists of two wire guide components 6 symmetrically arranged below the left side and the right side of the cutting device, the tension system consists of two tension components 7 symmetrically arranged below the left side and the right side of the cutting device, and the wire arrangement system consists of two wire arrangement components 9 symmetrically arranged below the left side and the right side of the cutting device.

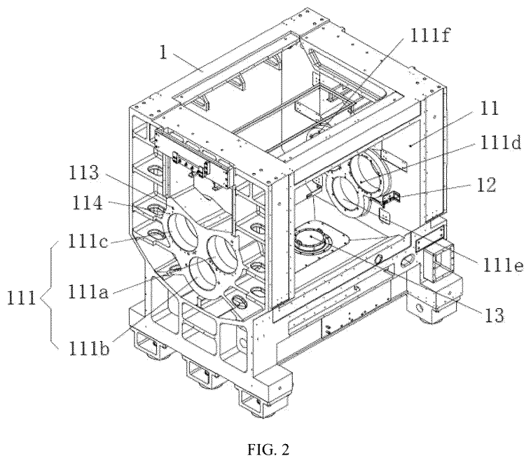

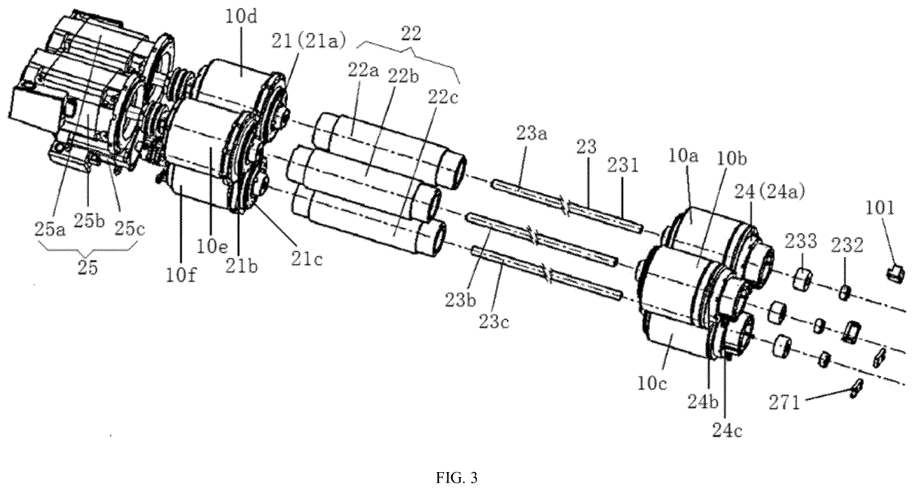

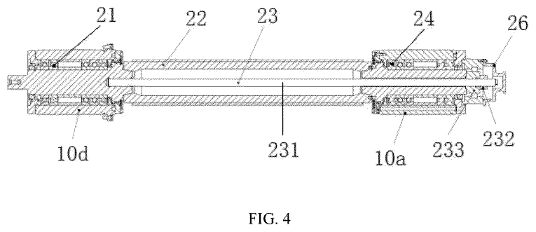

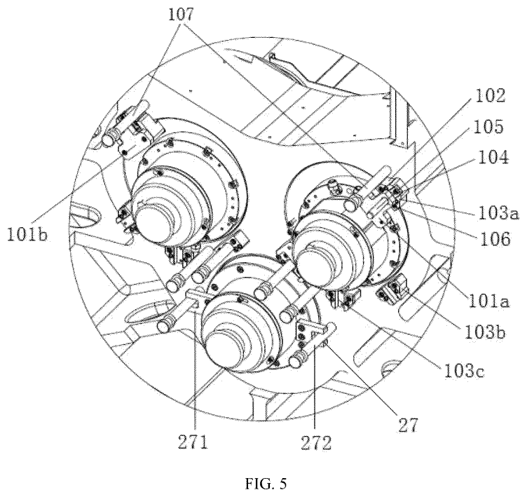

FIG. 2 shows a perspective structural diagram of an optional embodiment of a frame main body of a cutting device in FIG. 1; FIG. 3 shows a schematic exploded diagram of an optional embodiment of a main shaft system of the cutting device in FIG. 1; FIG. 4 shows a schematic sectional view of an optional embodiment of the main shaft system of the cutting device in FIG. 1; and FIG. 5 is a partial enlarged view of FIG. 1, showing a part of the cutting device, including a part of the main shaft system, eccentric shaft sleeves, limiting mechanisms, and support arms.

In the example, the cutting device includes a cutting head 1, a main shaft system 2, four eccentric shaft sleeves (10a, 10b, 10d, 10e), and two non-eccentric shaft sleeves (10c, 10f), where the cutting head 1 is provided with a frame main body 11 and six shaft holes 111 (111a, 111b, 111c, 111d, 111e, 111f); the main shaft system 2 includes three rollers 22 (22a, 22b, 22c) and three bearing box assemblies 21 and 24 (21a and 24a, 21b and 24b, 21c and 24c) for supporting the three rollers 22, and three locking screw assemblies 23 (23a, 23b, 23c) for locking axial positions of the rollers 22; the eccentric shaft sleeves 10a, 10b, 10d and 10e are mounted in the shaft holes 11a, 111b, 111d, and 111e, respectively; the shaft sleeves 10c and 10f are mounted in the shaft holes 111c and 111f, respectively; the bearing boxes 24a, 24b, 21a, and 21b are mounted in the eccentric shaft sleeves 10a, 10b, 10d, and 10e, respectively, and the bearing boxes 24c and 21c are mounted in the shaft sleeves 10c and 10f, respectively.

The support arms 101a and 101b are disposed on the eccentric shaft sleeves 10a and 10b, respectively, and a set of limiting mechanisms 102 is disposed near each of the shaft holes 111a and 111b, respectively; and each set of limiting mechanisms 102 includes three limiting clamping seats (103a, 103b, 103c) and fasteners 104. After the eccentric shaft sleeve 10a (10b) is inserted into the shaft hole 111a (111b), the support arm 101a (101b) can form a limiting fit with the limiting clamping seat 103a; and the fastener 104 fastens the support arm 101a to the limiting clamping seat 103a, and axial and radial positions of the eccentric shaft sleeve 10a (10b) are both locked. The limiting mechanism cooperating with 101b is shown in FIGS. 1 and 5 but not marked. The roller 22a and the roller 22b are located on a same horizontal plane, and the roller 22c is located below the roller 22a and the roller 22b. In such layout, the feeding system 3 is generally arranged above the main shaft system 2, and workpieces are disposed from top to bottom; and in addition, the roller 22c can also be located above the roller 22a and the roller 22b, and besides, the feeding system 3 is generally arranged below the main shaft system 2.

During operation, limitation to the support arm 101a by the limiting clamping seat 103a (if an initial state is that the support arm 101a is limited to the limiting clamping seat 103a) is released, and at the same time, a locking nut 232 of the corresponding locking screw assembly 23 (such as 23a) is axially loosened to pull out the eccentric shaft sleeve 10a from the shaft hole 111a; the eccentric shaft sleeve 10a is rotated by an angle, making the support arm 111a on the eccentric shaft sleeve 10a be aligned with the limiting clamping seat 103b or 103c, and then the eccentric shaft sleeve 10a is axially pushed into the shaft hole 111a in place (then, the locking nut 232 is re-mounted in place); the support arm 111a cooperates with the limiting clamping seat 103b or 103c and is locked by the fastener 104, and the angle of the eccentric shaft sleeve 10a is adjusted, so that a rotation center position of the bearing box 24a in the eccentric shaft sleeve 10a is adjusted; and during this process, pulling out the eccentric shaft sleeve 10d from the shaft hole 111d for corresponding adjustment can synchronously adjust the rotation center of the bearing box 21d in the eccentric shaft sleeve 10d, thereby adjusting the rotation center position of the roller 22a. The support arm 101a cooperates with different limiting clamping seats (103a, 103b, 103c) to limit the eccentric shaft sleeve 10a to different angles.

By using the same operation method mentioned above, the rotation center position of the roller 22b can be adjusted, and a distance between two adjacent rollers (22a and 22b) can be enlarged or decreased, so that the cutting device can adapt to diversified to-be-cut workpieces of different sizes and specifications. The operation process is simple and time-saving; at the same time, adjustment and locking of relative positions between the eccentric shaft sleeve 10 and the shaft hole 111 are achieved in a manner that the externally disposed support arm 101 and the externally disposed limiting mechanism 102 are in cooperation; compared with a direct positioning method using a pin shaft or a pin, usually used in the machinery field, the operation method mentioned above is higher in reliability; and because a pin hole corresponding to the pin shaft or the pin usually changes after multiple disassembly and assembly, causing accuracy to be reduced, but if the manner that the externally disposed support arm 101 and the externally disposed limiting mechanism 102 are in cooperation is adopted, the problem can be effectively solved.

As shown in FIGS. 1 and 3 to 5, the bearing boxes 24c and 21c are mounted in two non-eccentric shaft sleeves 10c and 10f, respectively so that the rotation center position of the roller 22c cannot be adjusted; a radial position of the shaft sleeve 10c is limited by position clamping mechanisms 27 so that the shaft sleeve 10f is fastened into the shaft hole 111f; each position clamping mechanism 27 includes a limiting rod 272 disposed on the frame main body 11 and a clamping block 271 disposed on the shaft sleeve 10c; clamping grooves matched with the limiting rods 272 are disposed in the clamping blocks 271; and two clamping blocks 271 and two limiting rods 272 are symmetrically arranged relative to a center of the shaft sleeve (10c or 10f). Three rollers 22a, 22b, and 22c are arranged in a triangular shape. By adjusting a distance between the rollers 22a and 22b, a width of a wire mesh can be adjusted, so that the cutting device can better adapt to the workpieces of different widths.

In addition, the shaft sleeves 10c and 10f can also be the same eccentric shaft sleeves as the eccentric shaft sleeves 10a or 10b (10d, 10e), and the position clamping mechanism 27 can be changed into a manner that the support arm and the limiting mechanism are in cooperation, so that the rotation center position of the roller 22c can also be adjusted. In this way, the rotation center positions of the three rollers (22a, 22b. 22c) can be adjusted, and thus the cutting device can better adapt to the workpieces of different widths, and can also better adapt to the workpieces of different heights.

As shown in FIGS. 1 and 3, the three rollers 22 (22a, 22b, 22c) are driven by three drivers 25 (25a, 25b, 25c), respectively. In addition, among the three rollers 22 (22a, 22b, 22c), the rollers 22a and 22b can also be driven by two drivers 25a and 25b, respectively, while the roller 22c can serve as a driven member.

As shown in FIGS. 3 and 4, the locking screw assembly 23 includes a screw 231, a locking nut 232, and a retaining ring 233, where the screw 231 locks shaft heads at two ends of the roller 22 axially, and the retaining ring 233 is mounted between one shaft head of the roller 22 and the locking nut 232. The bearing box 24 is fastened to the eccentric shaft sleeve 10 (or the eccentric shaft sleeve 10 can also be a part of a box body of the bearing box 24), a capped end cover 26 is disposed at an end, facing outward, of the bearing box 24, and the capped end cover 26 facilitates pulling-out and insertion of the eccentric shaft sleeve 10.

As shown in FIGS. 1 to 5, the eccentric shaft sleeves 10d, 10e, and 10f are fastened into the shaft holes 111d, 111e, and 111f through fastening elements. In addition, in another example, the eccentric shaft sleeves 10d, 10e, and 10f can also be mounted in the shaft holes 111d, 111e, and 111f in the same way as the eccentric shaft sleeves 10a, 10b, and 10c, that is, by disposing the support arms 101 on the eccentric shaft sleeves 10d, 10e, and 10f and disposing the limiting mechanisms 102 on the frame main body 11. On this basis, in another operation method of adjusting the rotation center position of the roller 22a, locking of the support arm 101a on the eccentric shaft sleeve 10a and the corresponding support arm on the eccentric shaft sleeve 10d which are at two ends of the roller 22a is released, and by pulling the capped end cover 26 at one end of the eccentric shaft sleeve 10a, the roller 22, along with the bearing boxes 21a and 24a at two ends of the roller 22, and the eccentric shaft sleeves 10a and 10d, is moved axially, where the eccentric shaft sleeves 10a and 10d are pulled out of the shaft holes 111a and 111d; the eccentric shaft sleeves 10a and 10b are rotated to desired angles, for example, the support arm 101a is aligned with the limiting clumping seat 103b or 103c, and then the capped end cover 26 is pushed to re-insert the eccentric shaft sleeves 10a and 10d into the shaft holes 111a and 111d, such that the support arm 101a on the eccentric shaft sleeve 10a cooperates with the limiting clamping seat 103b or 103c and is fastened by the fastener 104, the support arm on the eccentric shaft sleeve 10d cooperates with the corresponding limiting clamping seat and is fastened by the fastener, and the angles of the eccentric shaft sleeves 10a and 10d are adjusted, so that the rotation center position of the roller 22a is also adjusted (adjustment of the rotation center position of the roller 22a is equivalent to adjustment of a width of the wire mesh); and the same manner can be used to adjust the rotation center positions of the rollers 22b and 22c, and the adjustment process is basically consistent with that of the roller 22a, which will not be repeated here. By adopting the method, the operation is simple, convenient, and time-saving, and the efficiency of adjusting the rotation center position of the roller 22 can be greatly improved.

Referring to FIGS. 1 to 5, the cutting device can also be provided with only four eccentric shaft sleeves 10, four shaft holes 111 (111b, 111c, 111e, 111f), two rollers 22 (22b, 22c) in one set, corresponding bearing box assemblies (21, 24) in two sets, and 2 locking screw assemblies 23. That is, in this example, the cutting device includes the cutting head 1, the main shaft system 2, and the four eccentric shaft sleeves 10, where the cutting head 1 is provided with the frame main body 11 and the four shaft holes 111; the main shaft system 2 includes a set of rollers 22 and a set of bearing box assemblies (21, 24) for supporting the set of rollers 22, and the locking screw assemblies 23 for locking axial positions of the rollers 22; each of the four eccentric shaft sleeves 10 can be mounted in one of the four shaft holes 111 in an axial sliding manner; one bearing box (21 or 24) of one set of bearing box assemblies is disposed in each of the four eccentric shaft sleeves 10; one support arm 101 is disposed on each of the four eccentric shaft sleeves 10; four sets of limiting mechanisms 102 are disposed on the frame main body 11; each set of limiting mechanisms 102 is combined with one of the four shaft holes 111; each set of limiting mechanisms 102 includes at least two limiting clamping seats 103 and fasteners 104; after the eccentric shaft sleeves 10 are inserted into the corresponding shaft holes 111, the support arms 101 can form a limiting fit with the limiting clamping seats 103; the fasteners 104 are used for fastening the support arms 101 to the limiting clamping seats 103; and the support arms 101 cooperate with different limiting clamping seats (103a, 103b, 103c) in the at least two limiting clamping seats 103 to limit the eccentric shaft sleeves 10 to different angles.

Referring to FIGS. 1 to 3 and 5, each set of limiting mechanisms 102 further includes one guide rod 105, one guide mounting hole is formed in each limiting clamping seat 103 (103a, 103b, 103c), the guide rod 105 is mounted in the guide mounting hole, a guide hole 106 cooperating with the guide rod 105 is disposed in the support arm 101, and the guide rod 105 is parallel or roughly parallel to a centerline of the shaft hole 111, so that the eccentric shaft sleeve 10 integrated with the support arm 101 does not rotate during axial movement. The guide rod 105 can be mounted on another limiting clamping seat (103b or 103c, 103a or 103c, 103a or 103b) after being disassembled from one of the three limiting clamping seats 103 (such as 103a or 103b. 103c). In addition, the guide mounting hole can also be directly formed in the frame main body 11, that is, the guide rod 105 can be directly disposed on the frame main body 11.

Referring to FIGS. 1, 2, and 5, the three limiting clamping seats (103a, 103b, 103c) are located on the same plane. A distance between each of the three limiting clamping seats (103a, 103b, 103c) to the centerline of the corresponding shaft hole 111 is the same, and a distance between the limiting clamping seats 103a and 103b is different from or can also be the same as the distance between the limiting clamping seats 103b and 103c.

Referring to FIGS. 1 to 5, in one example, a trapezoidal groove is disposed in each limiting clamping seat 103 (103a, 103b, 103c), and a trapezoidal boss which can cooperate with the trapezoidal groove is disposed on the support arm 101a. Such cooperating structure makes position limitation of the limiting mechanism 102 on the support arm 101 and the eccentric shaft sleeve 10 more reliable. As shown in FIG. 5, side plates are also disposed on two sides of the support arm 101b, and the two side plates are used for clamping two sides of the limiting clamping seat cooperating with the side plates, thereby further improving positioning reliability of the limiting mechanism on the support arm and the eccentric shaft sleeve.

In addition, the number of the limiting clamping seats 103 may be 2, 4, or 5, and the number of the fasteners 104 may be the same as or less than the number of the limiting clamping seats 103; and the number of the fasteners 104 may also be 1. During adjustment, the fastener can be removed from the limiting clamping seat 103a and combined with the support arm 101 and the limiting clamping seat 103b.

In one example, as shown in FIGS. 1 and 5, the support arm 101 is mounted on the eccentric shaft sleeve 10 through fastened connection. In addition, the support arm 101 can also be welded to the eccentric shaft sleeve 10, and can also be fixedly connected to or integrated with the eccentric shaft sleeve 10. In addition, as shown in FIGS. 1 and 5, a plurality of stop rods 107 are also disposed on the frame main body 11. One of functions of the stop rod is to serve as a stop, but it does not mean that the stop rod only serves as the stop, and can also serve as a reference frame. In addition, the stop rods 107 can also play the same role as the limiting rod 272, and the stop rod and the limiting rod can also be interchanged. As shown in FIG. 2, stop rod mounting holes 113 and limiting clamping seat mounting holes 114 are formed in the frame main body 11.

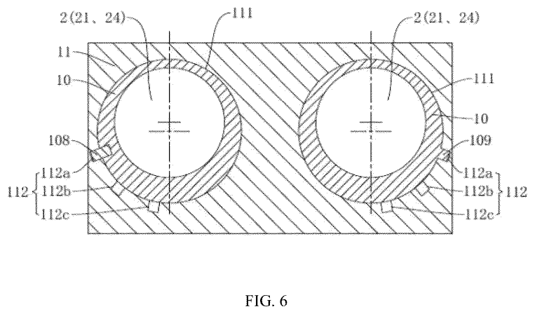

FIG. 6 is a partial sectional view of another optional embodiment of the cutting device in FIG. 1 or FIG. 5, showing a schematic cross-sectional view of shaft holes and the eccentric shaft sleeves of the frame main body, and reflecting two different cooperating structures. As shown in FIG. 6, one eccentric shaft sleeve 10 is mounted in each of the two shaft holes 111 of the frame main body 11, one bearing box (21 or 24) of the main shaft system 2 is mounted in each of the two eccentric shaft sleeves 10, and three sliding grooves 112 (112a, 112b, 112c) are formed in each shaft hole 111. In FIG. 6, a sliding key 108 is disposed on the left eccentric shaft sleeve 10, and cooperates with the sliding groove 112a. The eccentric shaft sleeves 10 are axially pulled out of the shaft holes 111 and rotated by an angle, and the sliding key 108 can also cooperate with the sliding groove 112b or 112c. In FIG. 6, a sliding tooth 109 is disposed on the right eccentric shaft sleeve 10, and cooperates with the sliding groove 11a. The eccentric shaft sleeves 10 are axially pulled out of the shaft holes 111 and rotated by an angle, and the sliding tooth 109 can also cooperate with the sliding groove 112b or 112c. When the sliding key 108 is combined with the sliding groove 112a, 112b or 112c, a radial angle of the eccentric shaft sleeve 10 is limited to a different position, and the eccentric shaft sleeve 10 does not rotate when moving axially. When the sliding tooth 109 is combined with the sliding groove 112a, 112b or 112c, a radial angle of the eccentric shaft sleeve 10 is limited to a different position, and the eccentric shaft sleeve 10 does not rotate when moving axially. In addition, the number of the sliding grooves 112 in each shaft hole 11l may be 2, 4, or more. In addition, referring to FIG. 6, the two eccentric shaft sleeves 10 may be both provided with the sliding keys 108 or the sliding teeth 109, which cooperate with the sliding grooves 112.

Referring to FIG. 6 and in conjunction with FIGS. 3 and 4, in one example, a set of rollers in the main shaft system 2 consists of 2 rollers 22, 4 bearing boxes (21, 24), and 2 locking screw assemblies 23.

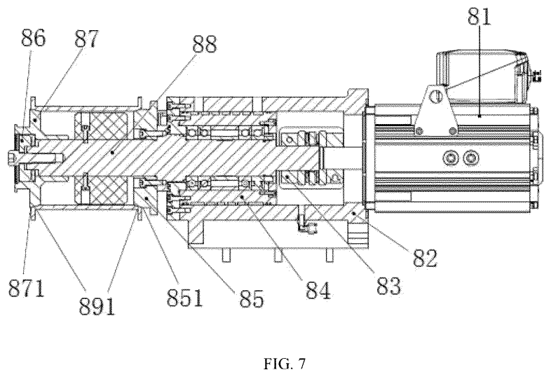

FIG. 7 is a schematic sectional view of an optional embodiment of a wire take-up and pay-off component in FIG. 1. The wire take-up and pay-off component 8 includes a wire take-up and pay-off motor 81, a bearing assembly 84, a coupling 83, a bearing seat 82, a wire take-up and pay-off shaft 88, a wire take-up and pay-off wheel 89, a rear cone cover 85, a front cone cover 87, and a locking end cover 86. The bearing seat 82 is mounted below the cutting head 1; the wire take-up and pay-off shaft 88 is rotatably disposed in the bearing seat 82 through the bearing assembly 84; one end of the wire take-up and pay-off shaft 88 is connected with the wire take-up and pay-off motor 81 through the coupling 83, and the other end thereof extends outward by a section; and the wire take-up and pay-off wheel 89 is mounted on the extended section of the wire take-up and pay-off shaft 88. Specifically, the wire take-up and pay-off wheel 89 is supported by the front cone cover 87 and the rear cone cover 85 which are mounted on the wire take-up and pay-off shaft 88, and is axially limited by the locking end cover 86. Furthermore, cone holes 891 in two ends of the wire take-up and pay-off wheel 89 cooperate with a cone body part 871 of the front cone cover 87 and a cone body part 851 of the rear cone cover 85, respectively.

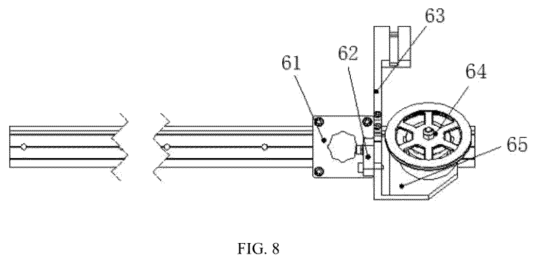

FIG. 8 is a perspective structural diagram of wire guide components in FIG. 1. The wire guide component 6 includes a sliding assembly 61, a guide wheel adjusting plate 62, a wire guide protective cover 63, a guide wheel mounting plate 65, and a first guide wheel assembly 64. The sliding assembly 61 is fixed below the cutting head 1, the guide wheel adjusting plate 62 is mounted on the sliding assembly 61, the guide wheel mounting plate 65 is mounted on the guide wheel adjusting plate 62, and the first guide wheel assembly 64 and the wire guide protective cover 63 are mounted on the guide wheel mounting plate.

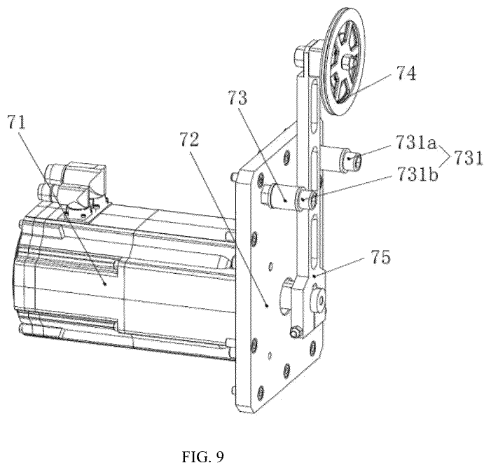

FIG. 9 is a perspective structural diagram of a tension component in FIG. 1. The tension component 7 includes a tension motor 71, a tension motor mounting plate 72, a tension swing rod 75, a tension limiting assembly 73, and a second guide wheel assembly 74. The tension motor mounting plate 72 is fixed below the cutting head 1 and located behind the wire take-up and pay-off component 8; the tension motor 71 is mounted on the tension motor mounting plate 72; the tension swing rod 75 is connected with the tension motor 71; the second guide wheel assembly 74 is mounted on the tension swing rod 75; and the tension limiting assembly 73 includes two limiting elements 731 (731a and 731b) mounted on two sides of the tension swing rod 75, respectively.

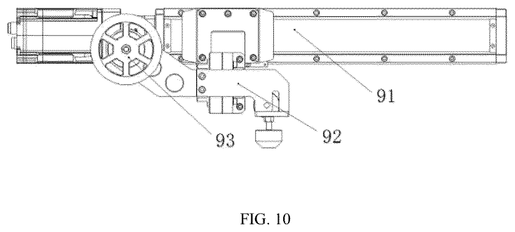

FIG. 10 is a perspective structural diagram of a wire arrangement component in FIG. 1. The wire arrangement component 9 includes a linear module 91, a connection and counterweight assembly 92, and a third guide wheel assembly 93. The linear module 91 is mounted below the cutting head 1, and between the wire guide component 6 and the wire take-up and pay-off component 8, the connection and counterweight assembly 92 is mounted on the linear module 91, and the third guide wheel assembly 93 is mounted on the connection and counterweight assembly 92.

Referring to FIG. 2, the cutting device further includes a wire breakage protection component 12 and a filter screen component 13, where the wire breakage protection component 12 includes four sets of wire breakage protection assemblies mounted inside the cutting head 1 and arranged on front and rear two sides of a set of rollers 22, respectively, and the filter screen component 13 is mounted at a bottom of the frame main body 11. FIG. 2 illustrates a set of wire breakage protection assemblies in the wire breakage protection component 12, while the other three sets are not shown due to being sheltered by other parts of the frame main body 11, but are symmetrically arranged on left and right sides of the set of rollers 22 and also symmetrically arranged relative to vertical planes of the rollers 22.

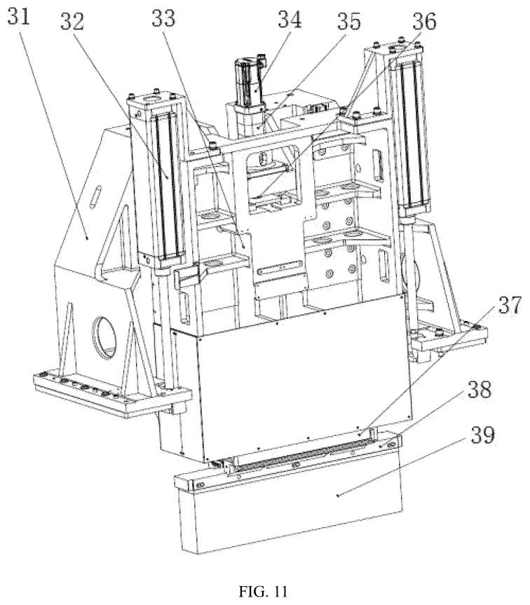

FIG. 11 is a perspective structural diagram of a feeding system in FIG. 1. The feeding system 3 includes a fixed seat 31, a sliding seat 33, a ball screw 36, air cylinders 32, a drive motor 34, a speed reducer 35, a locking assembly 37, and a workpiece support table 38, where the fixed seat 31 is mounted above the cutting head 1; the sliding seat 33 is connected with the fixed seat 31 through the air cylinders 32; the drive motor 34 is connected with the speed reducer 35; the speed reducer 35 is placed on the fixed seat 31 and connected with the ball screw 36; the locking assembly 37, the workpiece support table 38, and the sliding seat 33 are connected; the workpiece support table 38 is locked onto the sliding seat 33 by the locking assembly 37; the drive motor 34 controls movement of the ball screw 36 through the speed reducer 35 to control ascending and descending of the sliding seat 33; and the locking assembly 37 and the workpiece support table 38 ascend and descend along with the sliding seat 33. A workpiece 39 in the example is a long bar material, and the bar material 39 can be put in from a front or back of the cutting head 1.

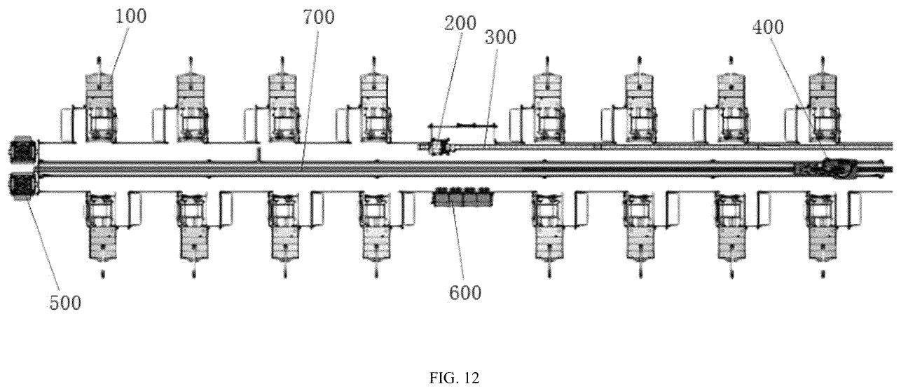

FIG. 12 shows a layout plan of an optional embodiment of a silicon ingot slicing production line. A silicon ingot slicing production line for slicing silicon ingots includes a track 700 arranged linearly, and a row of diamond wire multi-wire cutting machines 100 arranged on each of two sides of the track 700, where each row includes at least three diamond wire multi-wire cutting machines; a roller conveyor 300 for conveying workpieces with adhesive plates, as well as a charging machine 200 which cooperates with the roller conveyor 300 are arranged on one side of the track 700; a temporary storage table 600 for temporarily storing materials is arranged on the other side of the track 700; a loading and unloading robot 400 which can move along the track 700 is disposed on the track 700; a discharging machine 500 is disposed at a discharge end of the track 700; where, the charging machine 200 is used for rolling over the workpieces with adhesive plates conveyed by the roller conveyor 300, so that the adhesive plates of the workpieces with adhesive plates face upwards; the loading and unloading robot 400 is used for transporting the workpieces with adhesive plates to the temporary storage table 600, transporting the workpieces with adhesive plates on the temporary storage table 600 to the diamond wire multi-wire cutting machines 100, taking out the machined workpieces from the diamond wire multi-wire cutting machines 100 and moving the taken workpieces to the discharge end of the track 700; and the discharging machine 500 is used for receiving the machined workpieces and performing a discharging operation.

As shown in FIG. 12, the charging machine 200 and the temporary storage table 600 are located on two sides of a middle part of the track 700; and the roller conveyor 300, the charging machine 200, the temporary storage table 600, the discharging machine 500, and the track 700 are all mounted on the ground. The roller conveyor 300 is located between the track 700 and a row of diamond wire multi-wire cutting machines 100.

The above detailed explanation is explanatory, not restrictive. Therefore, the scope of the present invention should be determined by reference to the attached claims and the entire scope of the equivalents granted by these claims.

What is claimed is:

1. A cutting device, comprising:
a main shaft system, wherein the main shaft system comprises a set of rollers and a set of bearing box assemblies for supporting the set of rollers, as well as a set of locking screw assemblies used for locking axial positions of the rollers;
a cutting head, wherein the cutting head is provided with a frame main body and at least four shaft holes formed in the frame main body;
at least four eccentric shaft sleeves, wherein each of the at least four eccentric shaft sleeves is capable of being mounted in one of the at least four shaft holes in an axial sliding manner, and one of bearing boxes in the set of bearing box assemblies is disposed in each of the at least four eccentric shaft sleeves;
wherein one support arm is disposed on each of the at least four eccentric shaft sleeves; at least four sets of limiting mechanisms are disposed on the frame main body; each set of limiting mechanisms is combined with one of the at least four shaft holes; the each set of limiting mechanisms comprises at least two limiting clamping seats and fasteners; after the eccentric shaft sleeves are inserted into the corresponding shaft holes, the support arms are capable of forming a limiting fit with the limiting clamping seats; the fasteners are used for fastening the support arms to the limiting clamping seats; and the support arms cooperate with different limiting clamping seats among the at least two limiting clamping seats to limit the eccentric shaft sleeves to different angles.

2. The cutting device according to claim 1, wherein each set of limiting mechanisms further comprises at least one guide rod, a guide hole cooperating with the guide rod is formed in the support arm, and the guide rod is parallel or roughly parallel to a centerline of the shaft hole, so that the eccentric shaft sleeve integrated with the support arm does not rotate during axial movement.

3. The cutting device according to claim 2, wherein a guide mounting hole for mounting the guide rod is formed in each of the at least two limiting clamping seats, and the guide rod is capable of being mounted on another limiting clamping seat after being disassembled from one of the at least two limiting clamping seats; or the guide mounting hole is directly formed in the frame main body.

4. The cutting device according to claim 1, wherein the each set of limiting mechanisms comprises at least three limiting clamping seats and fasteners, the at least three limiting clamping seats are located on a same plane; and a distance from each of the at least three limiting clamping seats to a centerline of the corresponding shaft hole is the same, and a distance between any two adjacent limiting clamping seats of the at least three limiting clamping seats is the same as a distance between the other two adjacent limiting clamping seats.

5. The cutting device according to claim 1, wherein the support arm is disposed on the eccentric shaft sleeve by fastened connection or welding, fixed connection.

6. The cutting device according to claim 1, wherein the cutting device comprises six eccentric shaft sleeves, the cutting head is provided with six shaft holes, the main shaft system comprises three rollers and three bearing box assemblies for supporting the three rollers, and three locking screw assemblies for locking axial positions of the rollers; and six sets of limiting mechanisms are disposed on the frame main body.

7. The cutting device according to claim 1, wherein at least two sliding grooves are formed in each of the at least four shaft holes, one sliding key is in fastened connection or fixed connection to each of the at least four eccentric shaft sleeves or each of the at least four eccentric shaft sleeves is provided with one sliding tooth integrated with the eccentric shaft sleeve, and the sliding key or the sliding tooth is capable of cooperating with each of the at least two sliding grooves; and when the sliding key or the sliding tooth is combined with each of the at least two sliding grooves, a radial angle of the eccentric shaft sleeve is limited to a different position, and the eccentric shaft sleeve does not rotate when moving axially.

8. A diamond wire multi-wire cutting machine, comprising a machine frame, and a cutting device, a feeding system, a wire guide system, a tension system, a wire arrangement system and a wire take-up and pay-off system which are disposed on the machine frame, as well as a mortar bucket located below the machine frame, wherein the cutting device is the cutting device according to any of claim 1, and is mounted at a front end of the machine frame, the feeding system is mounted above the cutting device, the wire take-up and pay-off system consists of two wire take-up and pay-off components symmetrically arranged below a left side and a right side of the cutting device, the wire guide system consists of two wire guide components symmetrically arranged below the left side and the right side of the cutting device, the tension system consists of two tension components symmetrically arranged below the left side and the right side of the cutting device, and the wire arrangement system consists of two wire arrangement components symmetrically arranged below the left side and the right side of the cutting device.

9. A silicon ingot slicing production line, comprising:
a track, wherein the track is arranged linearly, a row of diamond wire multi-wire cutting machines is arranged on each of two sides of the track, and each row comprises at least three diamond wire multi-wire cutting machines according to claim 8;
a roller conveyor, wherein the roller conveyor is arranged on one side of the track, and used for conveying workpieces with adhesive plates;
a charging machine, wherein the charging machine cooperates with the roller conveyor, and is used for rolling over the workpieces with adhesive plates delivered by the roller conveyor, so that the adhesive plates of the workpieces with adhesive plates face upwards;
a temporary storage table, wherein the temporary storage table is arranged on one side of the track and opposite to the charging machine, and used for temporary storage of materials;
a loading and unloading robot, wherein the loading and unloading robot is movably disposed on the track, and used for transporting the workpieces with adhesive plates to the temporary storage table, transporting the workpieces with adhesive plates on the temporary storage table to the diamond wire multi-wire cutting machines, taking out the machined workpieces from the diamond wire multi-wire cutting machines and moving the taken workpieces to a discharge end of the track; and
a discharging machine, wherein the discharging machine is arranged at the discharge end of the track, and used for receiving the machined workpieces and performing a discharging operation.

10. The silicon ingot slicing production line according to claim 9, wherein the charging machine and the temporary storage table are located on two sides of a middle part of the track; the roller conveyor, the charging machine, the temporary storage table, the discharging machine, and the track are all mounted on the ground; and the roller conveyor is located between the track and the row of diamond wire multi-wire cutting machines.
